(19) United States
(12) Patent Application Publication
(10) Pub. No.: US 2007/0209652 A1
(43) Pub. Date: Sep. 13, 2007

(54) Barbecue chimney and utensil holder

(76) Inventor: David Alan Thompson, Stanton, CA (US)

Correspondence Address: DAVID ALAN THOMPSON, STE. J, 8440 CERRITOS AVE., STANTON, CA, 90680, US

(21) Appl. No.: 11/374,322

(22) Filed: Mar. 13, 2006

(51) Int. Cl. A47J 37/07; F24B 3/00

(52) U.S. Cl. 126/25 B; 126/9 R

(57) ABSTRACT

The invention is a portable barbecue charcoal briquette chimney starter and utensil and dish holder. It is designed to assist anyone wanting to ignite charcoal briquettes in a chimney starter in a place that is more convenient and safer than the methods now being employed. This invention, this device also allows the user a convenient place for the storage and use of barbecue utensils and dishes while barbecuing. This invention, this device is designed specifically for use with a popular kettle style barbecue.

### BACKGROUND OF THE INVENTION

1. Field of the Invention

The present invention introduces a device for use by anyone while barbecuing, needing and wanting a convenient and safe place to set a charcoal briquette starting chimney. This chimney can be placed upon the device while igniting the briquettes and once ignited due to it's close proximity, the coals are easily and safely discharged from chimney and into barbecue. The invention also offers storage for barbecue utensils.

2. Description of Related Art

A search of prior art did not disclose any patents that read directly on the claims of this instant invention.

### BRIEF SUMMARY OF THE INVENTION

The invention is used to aid anyone who while barbecuing, has a safe and convenient place that is in close proximity to the barbecue, for the placement of a charcoal briquette starting chimney and barbecue utensils. It has aspects of sheet metal that is bucket shaped and perforated for ventilation and the necessary hardware to attach the invention to said barbecue.

### BRIEF DESCRIPTION OF DRAWINGS

The invention will now be described, by way of example only, with reference to the accompanying drawings, as follows.

FIG. 1. Perspective side view of a preferred embodiment of the present invention.

FIG. 2. Perspective top view of a preferred embodiment of the present invention.

FIG. 3. Perspective bottom view of a preferred embodiment of the present invention.

### DESCRIPTION OF THE INVENTION

Detailed descriptions of the preferred embodiments of the present invention are provided herein. It is to be understood however, that the present invention may be embodied in various forms, therefore specific details disclosed herein are not to be interpreted as limiting, but rather as a basis for the claims and as a representative basis for teaching one skilled in the art to manufacture and employ the present invention in virtually any appropriately detailed system, structure or manner.

### DETAILED DESCRIPTION OF THE INVENTION

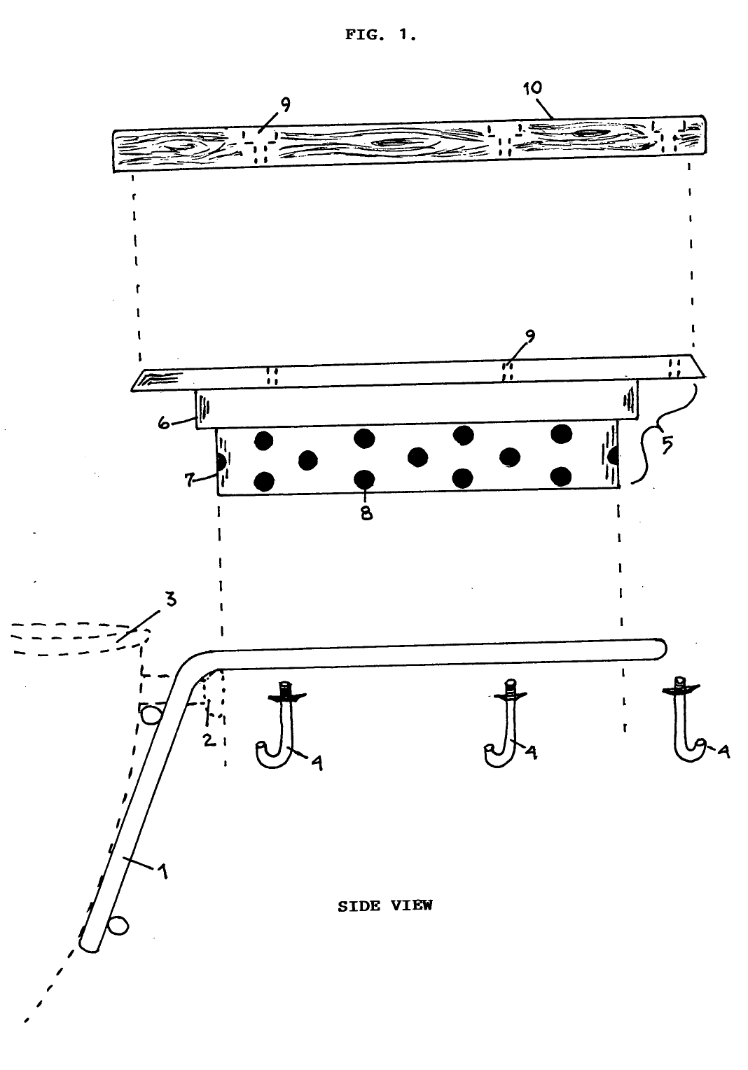

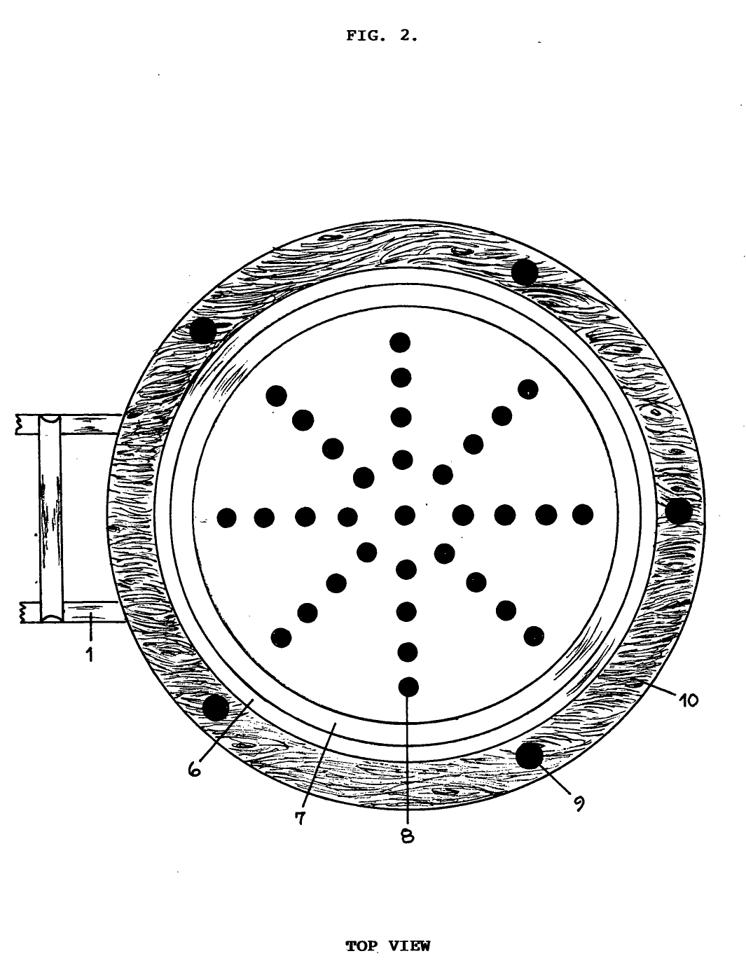

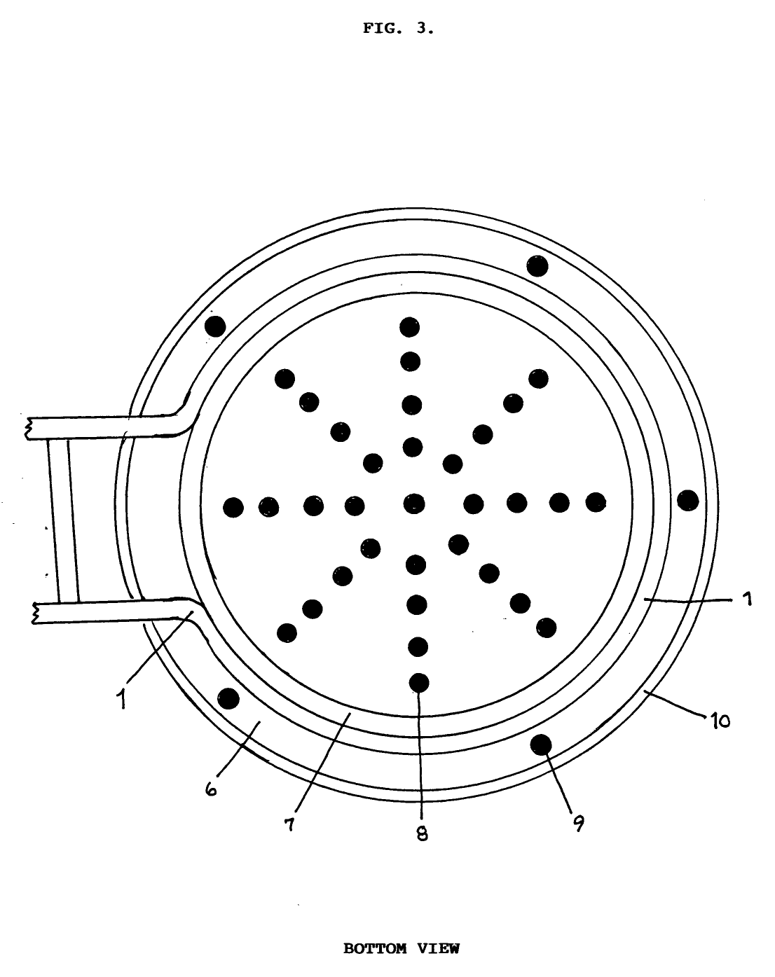

The present invention is a portable removable installable device that can be attached and or removed from a popular kettle style barbecue. This barbecue works well for barbecuing however it offers a less convenient place to operate a charcoal briquette chimney starter and no place for the chimney starter once coals are discharged into said barbecue. This style barbecue also offers a less convenient place to store barbecue utensils which include but is not limited to, tongs, fork, spatula, grill brush, pans, plates etc. This invention, this device offers a better, safer and more convenient place for above described items and more. The drawing of FIG. 1. represents a side view of the present invention which can be made of many types of metal and or a combination of metal, wood and the right type of plastic. Demonstrated in FIG. 1. is a round wooden ring (10). This wooden ring has counter sunk openings that allow for the introduction of rivets, bolts, screws etc. for assembly of the device (9). This wooden ring is designed for the placement of dishes while barbecuing. It has a round bucket shaped metal ring (5). This metal ring has openings that allow for ventilation (8). This ventilation is needed when using the device with a chimney to ignite the coals via burning paper. This metal ring is graduated for use with various size chimneys (7) and (6). It has hooks that are held in place when the device is assembled and these hooks are used to store barbecue utensils (4). It has a metal frame (1) that can be made from many types of metal in tubular or steel rod shaped accordingly. When the other parts of the device are assembled onto this frame, this chassis, the device as a whole can be mounted on a popular kettle style barbecue (3) via the opening at the handle (2). The steel chassis or frame (1) rests on top of the handle (2) and at barbecue (3). This arrangement is designed to safely hold 15 lbs. The drawing of FIG. 2. represents a top view of the device. It again has a wooden ring on top (10). It has recessed openings that allow for the introduction of rivets, bolts, screws etc. for assembly of the device (9). It has a bucket shaped metal ring that has graduated metal steps (6) and (7). These steps are for use with various size chimneys. At the base or bottom of this bucket shaped metal portion of the device are openings that allow for ventilation (8). This ventilation is needed when using a charcoal briquette chimney starter. It should also be noted that the size and pattern of these openings can vary. Also demonstrated in FIG. 2. is a portion of the metal frame that attaches the device to a popular kettle style barbecue (1). The drawing of FIG. 3. represents a bottom view of the device. Shown in FIG. 3. is the outer edge of the wooden ring (10). Also shown are the openings that allow for assembly of the device (9). The ventilation openings are shown at the bottom of the device (8). It also shows the graduated steps at the bucket shaped metal portion of the device (6) and (7). These steps are for use with various size chimneys. The formed metal frame or chassis is also shown (1).

While the present invention has been described in terms of several preferred embodiments, this is not intended to limit the invention to the particular forms set forth, on the contrary, the present invention is intended to cover such alternatives, alterations, modifications and equivalent structures and devices as may be included within the spirit and scope of the invention as defined within the appended claims.

I claim:

1. A portable barbecue chimney and utensil holder, comprising:
a circular bucket shaped main body;
a formed metal chassis attached to said body;
a wooden ring attached on top of main body;
an assortment of hooks attached to base of main body.

2. The portable barbecue chimney and utensil holder I further has a circular bucket shaped main body.

3. The portable barbecue chimney and utensil holder device of claim I further has graduated steps incorporated onto main body.

4. The portable barbecue chimney and utensil holder device of claim I further has ventilation openings at bottom and side of main body.

5. The portable barbecue chimney and utensil holder device of claim I further has openings located on top of main body.

6. The portable barbecue chimney and utensil holder device of claim I further has a formed metal chassis attached to main body.

7. The portable barbecue chimney and utensil holder device of claim I further has a wooden ring attached on top of main body.

8. The portable barbecue chimney and utensil holder device of claim I further has openings incorporated into said wooden ring.

9. The portable barbecue chimney and utensil holder device of claim has an assortment of hooks attached to main body.
